(19) United States
(12) Patent Application Publication
(10) Pub. No.: US 2023/0043405 A1
(43) Pub. Date: Feb. 9, 2023

(54) PRINTING UPON WEB MEDIA WITH TRACTOR-FEED HOLES

(71) Applicant: Hewlett-Packard Development Company, L.P., Spring, TX (US)

(72) Inventors: Leslie Drogo, San Diego, CA (US); Qian Wang, San Diego, CA (US)

(73) Assignee: Hewlett-Packard Development Company, L.P., Spring, TX (US)

(21) Appl. No.: 17/792,623

(22) PCT Filed: Jan. 29, 2020
(86) PCT No.: PCT/US2020/015687

§ 371 Date: Jul. 13, 2022

(51) Int. Cl. B41J 2/045; B41J 2/125; B41J 11/26; B41J 11/00; B41J 15/04

(52) U.S. Cl. CPC B41J 2/04573; B41J 2/125; B41J 11/26; B41J 11/0095; B41J 15/04

(57) ABSTRACT

In an example of the disclosure, a web media is advanced through a printer during a printing operation, Tractor-feed holes in a tractor-feed lane of the web media are detected utilizing a sensor and counted as the web media advances. When the count of tractor-feed holes reaches a target tractor-feed hole n, a fiducial detection period is started wherein a sensor is utilized to detect a fiducial. A printing adjustment is determined based upon a time or time period that the fiducial is detected during the fiducial detection period.

### BACKGROUND

A printer may apply marking agents to a paper or another media to produce an image upon the media. One example of printer is a web-fed printer device, wherein during production printing marking agent application components apply the marking agents to a web media fed to the printer device from a supply reel. In certain examples, the marking agent application components may apply the marking agent via inkjet (e.g., thermal inkjet or piezo inkjet) or dry toner printing technologies. In other examples, the marking agent application components may apply to the media an electrostatic printing fluid (e.g., electrostatically chargeable toner or resin colorant particles dispersed or suspended in a carrier fluid). Following the application of the marking agents, the web media may be collected on a take-up reel or cut into sheets by a finishing device that is in-line with the printer.

### DRAWINGS

FIG. 1 is a block diagram depicting an example of a system for printing upon web media with tractor-feed holes.

FIG. 2 is a block diagram depicting another example of a system for printing upon web media with tractor-feed holes.

FIGS. 3A, 3B, 3C, and 3D are simple schematic diagrams that illustrate an example of a system for printing upon web media with tractor-feed holes, wherein the fiducial is situated in a tractor-feed lane.

FIGS. 4A and 4B are simple schematic diagrams that illustrate another example of a system for printing upon web media with tractor-feed holes, wherein the fiducial is situated outside a tractor-feed lane.

FIG. 5 is a flow diagram depicting an example implementation of a method for printing upon web media with tractor-feed holes.

### DETAILED DESCRIPTION

Web-fed printers can be used to print commercial print jobs one after the other upon a media. Commonly finishing processing (e.g., a cutting, folding, stapling, and/or corrugating) of the printed jobs occurs at a finishing device separate from the web-fed printer device. In order to enable accurate duplexing printing and to enable the finishing device to operate precisely, the images printed upon the media must be properly registered. Web media can stretch and shrink as it absorbs water from the printing process and is subsequently dried in a dryer. If a printed image is out of position (e.g., an image is printed too far forward or too far back relative the web-advance direction, and/or out alignment with another image printed on an opposite side of the web media), the finishing operations can be significantly affected.

Currently, a top of form (“TOF”) mark may be printed on frames to be printed, the TOF mark is to be detected by a sensor during printing. The TOF mark is helpful for front to back and maintaining same side, and front to back, registration. However, with existing methods the TOF marks are placed in a content area of the frames to be printed. These methods can be suboptimal for certain use cases as the printed TOF marks may reduce the usable area of the printed frame and/or visually affect the printed product.

In some use cases, the web-fed printer is to print jobs on a web media that includes tractor-feed holes at the outer edges of the web media, in order that the finishing device that is separate from the printer may utilize a tractor system to move the media via the tractor-feed holes. When printing upon web media with tractor-feed holes, however, TOF marks are typically printed in a content area of the frame. Attempts to print and scan TOF marks in the tractor-feed holes lane, and thereby avoid having TOF mark artifacts in the content area, have largely been unsuccessful as the sensing systems could not consistently discern between the tractor-feed holes and the TOF marks.

To address these issues, various examples described in more detail below provide a system and a method for printing upon web media with tractor-feed holes. In an example of the disclosure, a printing system includes marking agent application components for printing an image upon a web media during a duplex printing operation. In a particular example the set of marking agent application components may be inkjet printheads, and may include a first set of printheads for printing on a first side of the web media, and a second set of printheads for printing on a second side of the web media. In examples, the disclosed system may include a supply reel and a take-up reel for moving the web media past the first set of printheads, past an optical sensor, and past the second set of printheads. The disclosed system is to, utilizing detection data received from an optical sensor, count tractor-feed holes in a tractor-feed lane of the web media. The disclosed system is to, during a fiducial detection period, utilize an optical sensor to detect a fiducial. In an example, the detection period begins when the count of tractor-feed holes reaches a target tractor-feed hole n, and ends before the count of tractor-feed holes reaches n+1. The disclosed system is to in turn implement a printing adjustment based upon comparison of a measured time of the detection of the fiducial with an expected time of detection of the fiducial. In one example, the disclosed system may determine a measured time period between detection of the fiducial and the start of the fiducial detection period, and the printing adjustment is made based upon a comparison of the measured time period with an expected time period between detection of the fiducial and the start of the fiducial detection period. In an example, the print timing adjustment is to adjust the timing of the ink ejection to compensate for the observed difference in measured and expected times or time periods of detection of the fiducial.

In one example, the fiducial to be detected is situated in the tractor-feed lane, and the sensor that is utilized to detect the fiducial is a same sensor as is utilized to detect and count the tractor-feed holes in a tractor-feed lane of the web media as the web media advances. In another example, the fiducial to be detected may be situated outside the tractor-feed lane. In this example, the sensor that is utilized to detect and count the tractor-feed holes in a tractor-feed lane of the web media as the web media advances is a first sensor, and a second sensor is used to detect the fiducial.

In this manner, the disclosed method and system enable a printer to print fiducials in the tractor-feed holes lane of the web media, versus the content area, with a single sensor being utilized for detecting the tractor-feed holes and the fiducial. In alternative scenarios the printing of the fiducial in the content lane may be acceptable or preferred. In these examples, the disclosed method and system enable the use of a first sensor for detecting the tractor-feed holes and a second sensor for detecting the fiducial, with the establishing of a defined fiducial detection period for the second sensor enabling greater fiducial-detection accuracy than is available with current methods. Users and providers of web media printing systems will appreciate the increased print quality, the cost savings of utilizing a single sensor in certain examples, and the reductions in production printing downtime and supplies waste afforded by the disclosure. Installations and utilization of printers that include the disclosed method and system should thereby be enhanced.

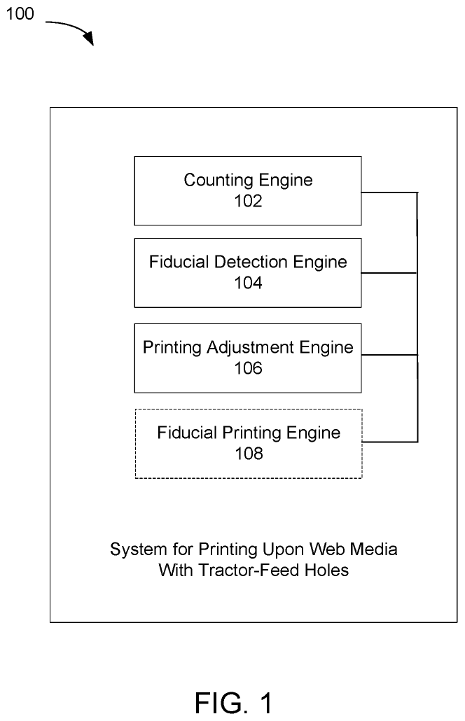

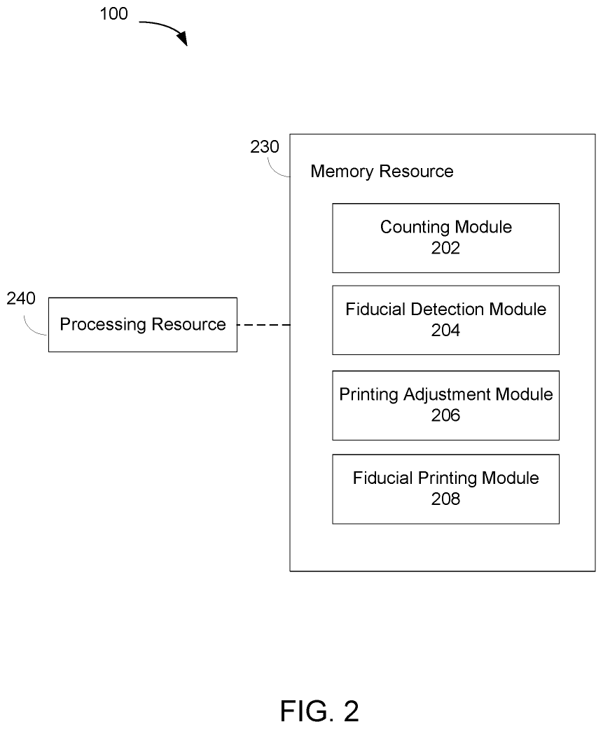

FIGS. 1, 2, 3A-3D, 4A, and 4B depict examples of physical and logical components for implementing various examples. In FIGS. 1, 2, 3A-3D, 4A, and 4B various components are identified as engines 102, 104, 106, and 108. In describing engines 102-108 focus is on each engine's designated function. However, the term engine, as used herein, refers generally to hardware and/or programming to perform a designated function. As is illustrated with respect to FIG. 2, the hardware of each engine, for example, may include one or both of a processor and a memory, while the programming may be code stored on that memory and executable by the processor to perform the designated function.

FIG. 1 is a block diagram depicting an example of a system 100 for printing upon web media with tractor-feed holes. In this example, system 100 may include a counting engine 102, representing generally a combination of hardware and programming to advance web media through a printer during a printing operation, and utilize detection data received from a sensor to count tractor-feed holes in a tractor-feed lane of the web media as the web media advances.

As used herein, “printer” and “printing device” are used synonymously and refer generally to any electronic device or group of electronic devices that consume a marking agent to produce a printed print job or form an image upon a media. As used herein, “marking agent” refers generally to any substance that can be applied upon a media by a printer during a printing operation to form an image upon a media, including but not limited to an ink. In examples, a printer may be, but is not limited to, a liquid inkjet printer, a liquid toner-based printer, a LEP printer that utilizes electrostatic printing fluid and a blanket, or a dry toner printing device. The term “printer” includes a multifunctional device that performs a function such as scanning and/or copying in addition to printing. As used herein, a “job” and “print job” are used synonymously and refer generally to content, e.g., an image, and/or instructions as to formatting and presentation of the content to be sent to a printer for printing. In examples, a print job may be stored in a programming language and/or a numerical form so that the job can be stored and used in computing devices, servers, printers and other machines capable of performing calculations and manipulating data. As used herein, an “image” refers generally to a rendering of an object, scene, person, or abstraction such text or a geometric shape. As used herein a “printing operation” refers generally to a print job receipt operation, a primer application operation, a marketing agent application operation, a drying operation, an overcoat application, a duplexing operation, a printer calibration operation, or any other process taking place at the printer that is to create, or set up the printer to create, a printed print job on a web media.

As used herein, “media”, “print media”, and “substrate” are used synonymously and refer generally to an article or object on which a printed image can be formed. As used herein, “web media”, “web substrate”, and “web” are used synonymously and refer generally to a media that is to pass through a printer as a continuous length starting at a web media supply reel and ending at a take-up reel. Typically, a web media is fed from a supply reel at one end of the printer, through a print zone. In examples, after application of marking agent, the web media may be wound upon a take-up reel at the opposite end of the printer. In examples, certain pre-printing events (e.g., application of primer) and/or post-print processing events (e.g., drying, application of overcoats, etc.) may occur at the printer, in addition to application of marking agent, to affect the web media before its collection at the take-up reel.

As used herein, a tractor-feed lane in a web media is a row of holes that are for engaging with a pin feed mechanism, e.g., a pin feed mechanism of a finishing device, such that the pin feed mechanism can advance the web media (e.g., advancing the web media through a finishing device). A “tractor-feed hole” refers generally to an individual hole of the row of holes comprising the tractor-feed lane. As used herein a “finishing device” refers generally to any non-printing device that is to perform an operation upon already printed upon media. In examples, the operation may be cutting, folding, stapling, corrugation assembly, or any other finishing operation.

In examples, counting engine 102 is to advance the web media through the printer utilizing a supply reel and a take-up reel. In an example, the supply reel and take-up reel, and a set of intermediate rollers for supporting the web media lengths between the supply reel and the take-up reel, are to move the web media past a first set of marking agent application components, past an optical sensor, and past the second set of marking agent application components. In examples, the tractor-feed holes in the web media are not used for transporting the web media through the printer, but rather are for use, after printer operations at the printer, in transporting the web media through a finishing device that has a pin feed web media advance mechanism. In an example, the web media that is collected upon the take-up reel is to form a roll, and the roll may be moved from the printer to a finishing device such that what was the take-up reel at the printer becomes the supply reel at the finishing device.

Counting engine 102 utilizes the detection data to count tractor-feed holes in a tractor-feed lane of a web media as the web media advances. In examples, the detection data is data received from an optical sensor. As used herein an “optical sensor” refers generally to any electronic device that is to detect light, or a change in light, and convey information or data regarding the light or change of light via an electronic signal.

Continuing with the example of FIG. 1, system 100 may include a fiducial detection engine 104. Fiducial detection engine 104 represents generally a combination of hardware and programming to start a fiducial detection period when the counting engine 102's count of tractor-feed holes reaches a target tractor-feed hole n. During the fiducial detection period fiducial detection engine 104 utilizes a sensor to detect a fiducial. As used herein, a “fiducial detection period” refers generally to a window of time wherein a sensor is being utilized to detect a fiducial. In examples, fiducial detection engine 104 is not utilizing the sensor to detect a fiducial during times outside of the fiducial detection period. As used herein a “fiducial” refers generally to a geometrical shape or other visual feature that may be placed in the focal plane of a sensor or scanner and used as a reference point, e.g. for establishing a registration point for duplex printing. In a particular example, the fiducial is a TOF mark in a square or other rectangular shape, to be easily differentiated from the generally circular or oval tractor-feed holes in the tractor-feed lane of the web media. In other examples, the fiducial may be, but is not limited to, an oval, line segment, dot, spot, or cross shaped fiducial. In other examples, the fiducial may include any number of ovals, line segments, dots, spots, or cross shapes, spaces or other visual attributes.

In one example, the fiducial to be detected is situated in the tractor-feed lane of the web media, and the sensor that fiducial detection engine 104 utilizes in detecting the fiducial is the same sensor as counting engine 102 utilizes in detecting and counting the tractor-feed holes in a tractor-feed lane of the web media as the web media advances. This arrangement has the benefits of low cost and simplicity as a single sensor is utilized in performing the tractor-feed hole detection/counting and in performing the fiducial detection tasks.

In another example, the fiducial to be detected may be situated outside the tractor-feed lane. In this example, the sensor that fiducial detection engine 104 utilizes to detect the fiducial is a first sensor, and a second sensor is utilized by counting engine 102 to detect and count the tractor-feed holes in a tractor-feed lane of the web media as the web media advances. This arrangement can be beneficial where the fiducial is to appear in the content area of a frame to be printed, as utilizing a fiducial detection period of window for fiducial detection allows the system 100 to avoid false readings, or missed readings, of the fiducial that might otherwise occur. As used herein, a “frame” refers generally to a specified length or incidence of a web media. “Content area” of a frame refers generally to a portion of the frame that includes an image, text, or other content that is for display to a user. For instance, for a series of advertising brochure frames to be printed upon a web media, the photos and text can be described as being situated in a content area of the frame, and the tractor-feed holes lane that includes tractor-feed holes for conveying the web media through the finishing device can be described as being situated in a non-content area of the frame. In examples, the tractor-feed holes may be removed by a cutting operation at a finishing device.

In an example, the fiducial detection period is to begin upon fiducial detection engine 104, having detected, utilizing a sensor, the leading edge of the target tractor-feed hole n. In another example, the fiducial detection period is to begin upon fiducial detection engine 104 having detected the trailing edge of the target tractor-feed hole n. In another example, the fiducial detection period is to begin upon fiducial detection engine 104 having determined the elapsing of a predetermined time following a detection of the leading edge of the target tractor-feed hole n. In examples, the fiducial detection period is to end before the count of tractor-feed holes reaches n+1, e.g., before the counting engine 102 detects a tractor-feed hole that follows tractor-feed hole “n.”

Continuing with the example of FIG. 1, system 100 may include a printing adjustment engine 106. Printing adjustment engine 106 represents generally a combination of hardware and programming to determine a printing adjustment based upon a time the fiducial is detected during the fiducial detection period. In examples, the printing adjustment may be determined based upon a comparison of a measured time, or time period, between the start of the fiducial detection period and the detection of the fiducial, and an expected time, or time period, between the start of the fiducial detection period and the detection of the fiducial. In a particular example, the printer includes a plurality of marking agent application components, and the printing adjustment is to control the marking agent application components to adjust the timing of marking agent application for second side printing. For instance, if the printing adjustment module 206 determines the web media has expanded to where the fiducial is detected on a first side of the media during the fiducial detection period, but after the expected time or time period, the determined printing adjustment may be to cause a compensatory delay in the printing of an image on the second side of the web media. The compensatory delay is to cause a proper registration between the images printed on the first and second sides of the media. Similarly, if the printing adjustment module 206 determines the web media has contracted to where the fiducial is detected on a first side of the media during the fiducial detection period, but before the expected time or time period, the determined printing adjustment may be to cause a compensatory acceleration in the printing of the image on the second side of the web media to effect proper registration between the images printed on the first and second sides of the media.

In a particular example the plurality of marking agent application components may be a plurality of inkjet printheads, including a first set of printheads for printing on a first side of the web media, and a second set of printheads for printing on a second side of the web media. In this example, the determined printing adjustment may be to adjust the ink ejection timing of the second set of printheads as they print on the second side of the web media, and thereby cause a second image frame printed on the second side to be in proper registration with a first image frame that was printed by the first set of printheads on the first side of the web media. As used herein, a “printhead” refers generally to a mechanism for ejection of a liquid marking agent. In examples the ejected liquid making agent is an ink. Examples of printheads are drop on demand printheads, such as piezoelectric printheads and thermo resistive printheads. Some printheads may be part of a cartridge which also stores the liquid to be dispensed. Other printheads are standalone and are supplied with liquid by an off-axis liquid supply.

In certain examples, system 100 may include a fiducial printing engine 110. Fiducial printing engine 110 represents generally a combination of hardware and programming to cause a first set of marking agent application components at a printer to print fiducials upon a first side of a web media. The fiducials are to serve as TOF mark reference points for second side printing upon the web media at the printer performed utilizing a second set of marking agent application components. The fiducials are to be detected by a sensor situated downstream (relative to direction the web media advances through the printer) from the first set of marking agent application components. In a particular example, the first set of marking agent application components at the printer is a first set of inkjet printheads, and the second set of marking agent application components is a second set of inkjet printheads. In this example the first set of inkjet printheads is to print the fiducial that serves as a TOF mark on the first side of the media as registration reference for first side printing of frame content.

In another example, the fiducials may be fiducials that are situated upon the web media before the web media advances to the first set of printheads. In this example, the fiducials may have been placed upon the web media by a previous printing operation at the printer that includes the first and second sets of printheads, or by a previous printing operation at another printing device.

In the foregoing discussion of FIG. 1, counting engine 102, fiducial detection engine 104, printing adjustment engine 106, and fiducial printing engine 108 were described as combinations of hardware and programming. Engines 102-108 may be implemented in a number of fashions. Looking at FIG. 2 the programming may be processor executable instructions stored on a tangible memory resource 230 and the hardware may include a processing resource 240 for executing those instructions. Thus, memory resource 230 can be said to store program instructions that when executed by processing resource 240 implement system 100 of FIG. 1.

Memory resource 230 represents generally any number of memory components capable of storing instructions that can be executed by processing resource 240. Memory resource 230 is non-transitory in the sense that it does not encompass a transitory signal but instead is made up of a memory component or memory components to store the instructions. Memory resource 230 may be implemented in a single device or distributed across devices. Likewise, processing resource 240 represents any number of processors capable of executing instructions stored by memory resource 230. Processing resource 240 may be integrated in a single device or distributed across devices. Further, memory resource 230 may be fully or partially integrated in the same device as processing resource 240, or it may be separate but accessible to that device and processing resource 240.

In one example, the program instructions can be part of an installation package that when installed can be executed by processing resource 240 to implement system 100. In this case, memory resource 230 may be a portable medium such as a CD, DVD, or flash drive or a memory maintained by a server from which the installation package can be downloaded and installed. In another example, the program instructions may be part of an application or applications already installed. Here, memory resource 230 can include integrated memory such as a hard drive, solid state drive, or the like.

In FIG. 2, the executable program instructions stored in memory resource 230 are depicted as counting module 202, fiducial detection module 204, printing adjustment module 206, and fiducial printing module 208. Counting module 202 represents program instructions that when executed by processing resource 240 may perform any of the functionalities described above in relation to counting engine 102 of FIG. 1. Fiducial detection module 204 represents program instructions that when executed by processing resource 240 may perform any of the functionalities described above in relation to fiducial detection engine 104 of FIG. 1. Printing adjustment module 206 represents program instructions that when executed by processing resource 240 may perform any of the functionalities described above in relation to printing adjustment engine 106 of FIG. 1. Fiducial printing module 208 represents program instructions that when executed by processing resource 240 may perform any of the functionalities described above in relation to fiducial printing engine 108 of FIG. 1.

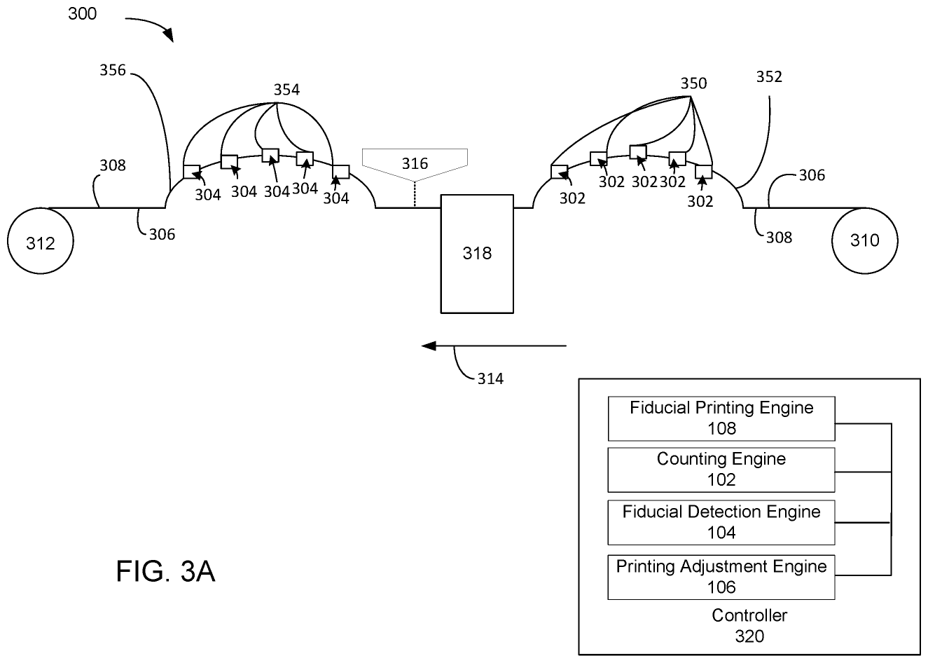

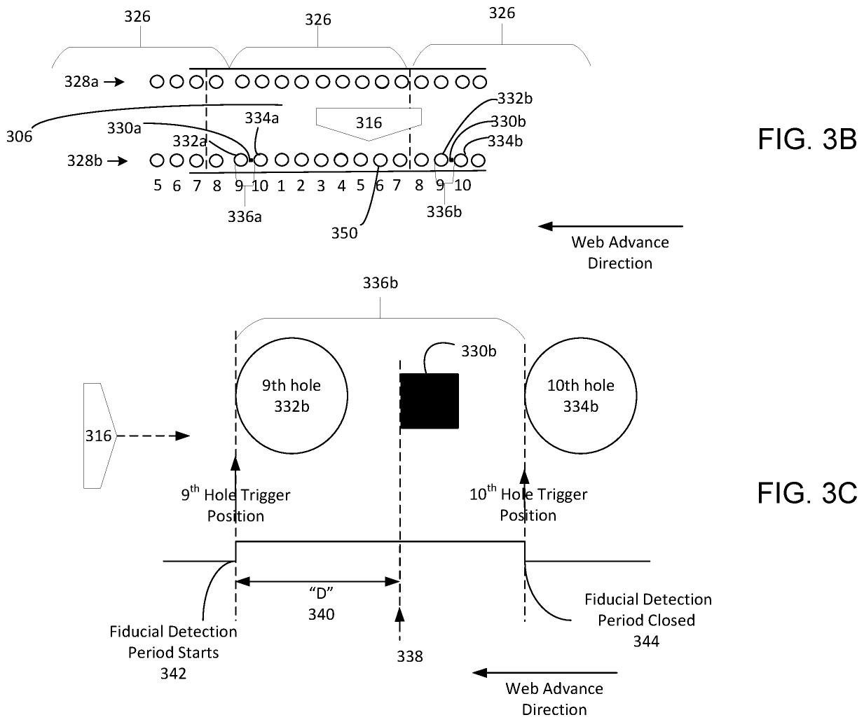

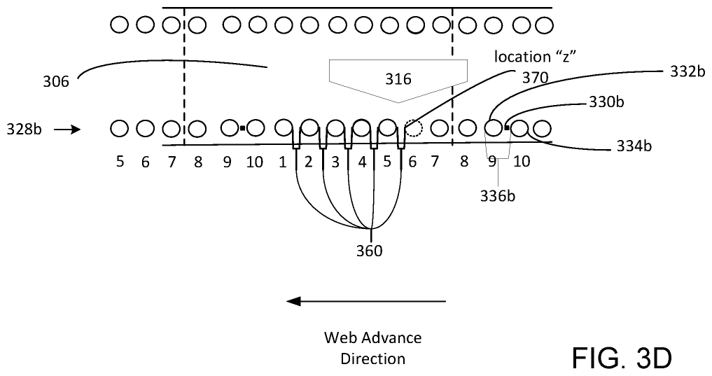

FIGS. 3A, 3B, 3C, and 3D are simple schematic diagrams that illustrate an example of a system for printing upon web media with tractor-feed holes, wherein the fiducial is to be situated in a tractor-feed lane. Beginning at FIG. 3A, in this example, a printer 300 includes a first set of printhead marking agent application components 302 and second set of printhead marking agent application components 304 for printing an image upon a web media during a duplex printing operation. The first set of printheads 302 is for printing on a first side 306 of the web media, and the second set of printheads 304 is for printing on a second side 308 of the web media.

Printer 300 includes a supply reel 310 and a take-up reel 312 for moving the web media in a web direction 314 successively past the first set of printheads 302 situated on a first printbar 302, past an optical sensor 316, and past the second set of printheads 304 situated on a second printbar 304.

In this example, printer 300 includes a web inversion component 318 that is to invert the orientation of the web media to accommodate the duplex printing. In this example, as a first side 306 of a portion of the web media passes the first set of printheads 302 the first side of the portion is positioned to receive marking agent. After passing through the web inversion component 318 and beneath the second set of printheads 304, the second side 308 of that portion of the web media is positioned to receive marking agent. Printer 300 includes optical sensor 316 positioned to face the second side 308 of the web media, the optical sensor for detecting tractor-feed holes of the web media in a tractor-feed lane, and for detecting fiducials printed upon the second side 308 of the web media situated within the tractor-feed lane. In examples the fiducials may be situated completely within the tractor-feed lane. In other examples, the fiducials may be partially situated within the tractor-feed lane.

Printer 300 includes a controller 320. In the example of FIGS. 3A, 3B, 3C, and 3D, controller 320 represents a combination of hardware and programming that is to control part, or all, of the components and print process at printer 300, including controlling the system 100 for printing upon web media with tractor-feed holes at printer 300. In this example, controller 320 includes a fiducial printing engine 108 (FIG. 1), a counting engine 102 (FIG. 1), a fiducial detection engine 104 (FIG. 1), and a printing adjustment engine 106 (FIG. 1).

FIG. 3B provides a top-down view of the first side 306 of the web media as it passes optical sensor 316 at printer 300. In this example, a first set of printheads 302 (FIG. 3A) at the printer has printed print multiple frames 326 that will include production images upon the first side 306. In this example, the web media includes a first tractor-feed holes lane 328a and a second tractor-feed hole lane 328b, with each lane including a row of tractor-feed holes. In this example, the controller 320 caused the first set of printheads 302 to print fiducials (e.g., 330a and 330b) between every ninth (e.g., 332a and 332b) and tenth (e.g., 334a and 334b) detected tractor-feed holes (e.g., 330a and 330b) in the second tractor-feed hole lane 328b (assuming a tractor-feed hole counting regimen where the numbering of holes restarts at “1” after every 10^{th} tractor-feed hole), In a particular example, the printed fiducials 330a 330b are to serve as TOF reference points for identifying tops of frames 326 and ensuring proper registration when the second set of printheads 304 (FIG. 3A) at the printer prints a second set of frames on the second side 308 (FIG. 3A) of the web media opposite a first set of frames 326 printed on the first side 306 (FIG. 3A),

FIG. 3C provides a close-up view of the optical sensor 316, a fiducial 322b, the tractor-feed hole 322b that precedes the fiducial 330b, and the tractor-feed hole 334b that follows the fiducial 330b. In this example, controller 320, utilizing detection data received from the optical sensor 316, causes a counting of the tractor-feed holes 332b in the tractor-feed lane of the web media. In this example, controller 320, upon reaching a count of nine tractor-feed holes since the closing of a last fiducial detection period 336a starts a new fiducial detection period 336b.

In the example of FIGS. 3B and 3C, a first fiducial detection period 336 closes upon the optical sensor 316 having detected a tractor-feed hole 334a (the tractor-feed hole that immediately followed tractor-feed hole 330a, that when detected by optical sensor 316 caused the opening of the first fiducial detection period. A new, second fiducial detection period 336b opens upon the optical sensor detecting the 9^{th} tractor-feed hole 332b following the closing of the first fiducial detection period 336a.

Once the new fiducial detection period 336b, or window, has begun or opened, controller 320 is to utilize the optical sensor 316 to detect the fiducial 330b. In one example, controller 320 is to implement a printing adjustment based upon comparison of a measured time 338 of the detection of the fiducial with an expected time of detection of the fiducial. In another example, controller 320 is to determine a measured time period “D” 340 between detection of the fiducial 330b and the start of the fiducial detection period 342, In this example, the printing adjustment is made based upon a comparison of the measured time period D 340 with an expected time period between detection of the fiducial 330b and the start 342 of the fiducial detection period 336b.

Returning to FIG. 3A, in view of FIGS. 3B and 3C, the printing operation being performed at printer 300 is a duplex printing operation including printing on the first side of the web media 306 and printing on the second side 308 of the web media. The detection of the fiducials, including fiducial 330a (FIGS. 3B and 3C) and fiducial 330b (FIGS. 3B and 3C) on the first side is to occur during printing or following printing on the first side 306, In certain examples, the print timing adjustment determined by controller 320 is to adjust timing of the second set of printheads 304 starting the printing of a second frame on the second side 308 of the web media so as to be in registration with a first frame 326 (FIG. 3B) printed on the first side 306 of the web media.

In this particular example, the first set of printheads 302 is included within a first set of printbars 350 situated upon a first arch 352 supporting element, and the second set of printheads 304 is included within a second set of printbar 354 situated upon a second arch 356 supporting element. This printheads/printbars/arch arrangement allows for accurate placement of printheads such that the print adjustment that controller 320 determined, e.g. an ink ejection timing adjustment for the second set of printheads, may be accurately implemented. This printheads/printbars/arch arrangement also promotes ease of user access to the printheads when printhead replacements are made.

Moving to FIG. 3D, one issue that can arise with detecting holes in tractor-fed media 306 is that if a tractor-feed hole, e.g., an expected tractor-feed hole in lane 328b is not fully punched, the optical sensor 316 may not detect it, By the counting engine 102 accessing from memory one or more predicted distances 360 between tractor-feed holes, controller 320 can compensate for a missed hole and maintain the fiducial detection period in the correct timing and location. In one example, a predicted distance 360 between tractor-feed holes may be stored in the memory after having been provided by a press operator via a user interface (e.g., a keyboard, mouse, etc.). In another example, a predicted distance 360 between tractor-feed holes may be stored in the memory after having been determined by the counting engine 102 taking measurements of the tractor-feed hole distances utilizing the optical sensor 316 as the web media 306 is moved past the sensor.

Continuing at FIG. 3D in view of FIG. 3A, in an example, counting engine 102 may determine utilizing detection data form the optical sensor 316 and predicted distances 360 between tractor-feed holes that the expected tractor-feed hole 6 at a location z 370 was not detected by the optical sensor. Upon determining the expected tractor-feed hole 6 at location z 370 is missing, counting engine 102 may count a virtual tractor-feed hole 6 at the location z. For instance, if counting engine 102 counts 5 holes and determines the 6th hole is missing as it was not fully punched out during creation of the tractor-feed lane, counting engine 102 can, by making a distance/timing conversion, count the 6^{th} hole virtually in the timing and location that the 6th hole should have been detected. The fiducial detection engine 104 can in turn determine the fiducial detection period 336b for detecting fiducial 330b based upon a tractor-feed holes count that includes the virtual tractor-feed hole 6 at location z 370.

In the example of FIG. 3D, the virtual tractor-feed hole 6 is a tractor-feed hole 6 that is not a target tractor-feed hole n and its detection by optical sensor 316 does not immediately cause opening or starting of the fiducial detection period 336b. In other examples not illustrated in FIG. 3D any of the tractor-feed holes of lane 328b, including, but not limited to target tractor-feed hole 9 332b (that when detected starts the fiducial detection period 336b) and tractor-feed hole 10 334b (that when detected closes the fiducial detection period 336b) may be counted as a virtual hole as described in the preceding paragraph.

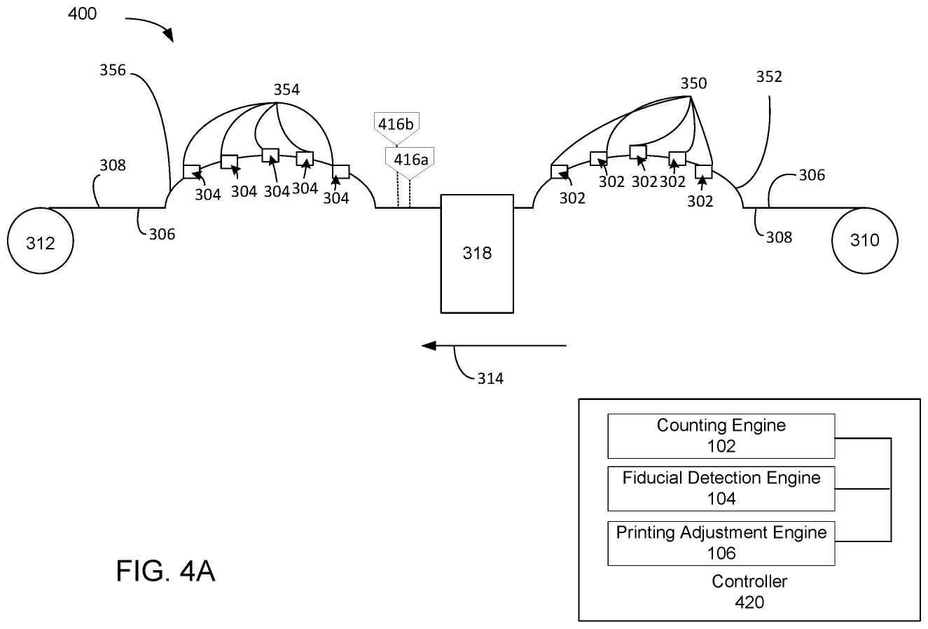

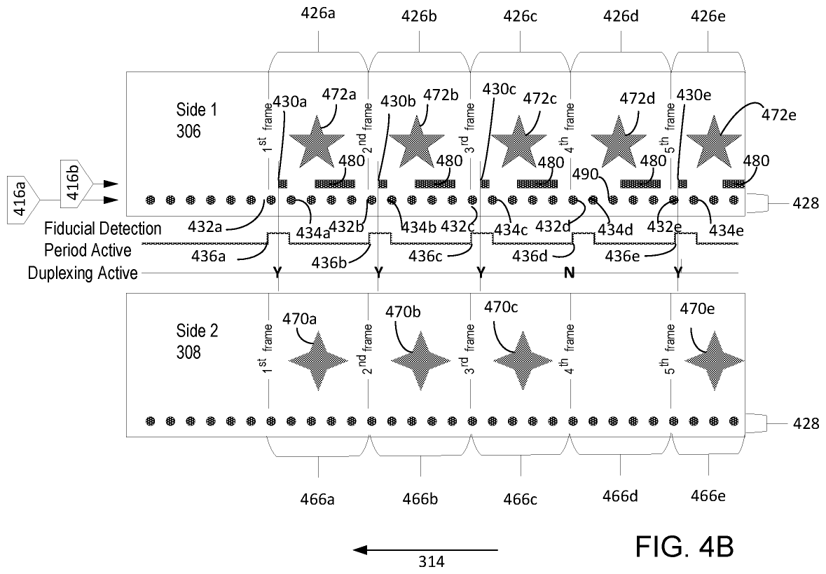

FIGS. 4A and 4B are simple schematic diagrams that illustrate an example of a system for printing upon web media with tractor-feed holes, wherein the fiducial to be detected is situated outside a tractor-feed lane. Beginning at FIG. 4A, in this example, a printer 400 includes similar components as the printer 300 of FIG. 3A, except that printer 400 includes a first optical sensor 416a and a second optical sensor 416b positioned to face the second side 308 of the web media. First optical sensor 416a is for detecting tractor-feed holes of the web media in a tractor-feed lane. Second optical sensor 416B is for detecting fiducials printed upon the first side 306 of the web media outside to the tractor-feed lane. Printer 400 includes a controller 420. In the example of FIGS. 4A and 4B, controller 420 represents a combination of hardware and programming that is to control part, or all, of the components and print process at printer 400, including controlling the system 100 for printing upon web media with tractor-feed holes. In this example, controller 420 includes a fiducial printing engine 108 (FIG. 1), a counting engine 102 (FIG. 1), and a fiducial detection engine 104 (FIG. 1).

FIG. 4B provides a top-down view of the first side 306 of a web media as it is to advance in a web direction 314 past the optical sensors 416a and 416b at the printer 400. In this example, a first set of printheads 302 (FIG. 4A) at the printer has printed print multiple frames 426a-426e that include first side production images 472a-e. The web media includes a tractor-feed holes lane 428 that includes a row of tractor-feed holes. Controller 420, utilizing detection data received from the first optical sensor 416a, causes a counting of the tractor-feed holes in the tractor-feed lane 428 of the web media.

In the example of FIG. 4B, controller 420, upon each instance of reaching a count of four tractor-feed holes since the closing of a last fiducial detection period starts a new fiducial detection period. For instance, a first fiducial detection period 436a begins or is opened when the first optical sensor 416a detects the leading edge of tractor-feed hole fiducial 432a, and closes upon the optical sensor 416a having detected the leading edge of the next occurring tractor-feed hole 434a. A new, second fiducial detection period 436b begins or opens when the first optical sensor 416a detects the leading edge of a fourth tractor-feed hole 432b observed or counted following the tractor-feed hole 434a that, when detected by optical sensor 416a, caused closing of the first fiducial detection period 436a. A third fiducial detection period 436c begins or opens when the first optical sensor 416a detects the leading edge of a fourth tractor-feed hole 432c that is observed or counted after tractor-feed hole 434b that, when detected by optical sensor 416a, caused closing of the first fiducial detection period 436b. A fourth fiducial detection period 436d begins or opens when the first optical sensor 416a detects the leading edge of a fourth tractor-feed hole 432d that is observed or counted after tractor-feed hole 434c that, when detected by optical sensor 416a, caused closing of the first fiducial detection period 436c. A fifth fiducial detection period 436e begins or opens when the first optical sensor 416a detects the leading edge of a fourth tractor-feed hole 432e that is observed or counted after tractor-feed hole 434d that, when detected by optical sensor 416a, caused closing of the first fiducial detection period 436d.

Once the first fiducial detection period 436a, or window, has begun or opened, controller 420 is to utilize the second optical sensor 416b to detect the fiducial 430a. In one example, controller 420 is to implement a printing adjustment of the second side image 470a to be based upon comparison of a measured time of the detection of the fiducial 430a with an expected time of detection of the fiducial. In another example, controller 420 is to determine a measured time period between detection of the fiducial 430a and the start of the fiducial detection period 436a. In this example, the printing adjustment for the printing of second side image 470a is made based upon a comparison of the measured time period with an expected time period between detection of the fiducial 430a and the start of the fiducial detection period 436a. In an example, the printing adjustment to be made is to adjust timing of the second set of printheads 304 (FIG. 4A) starting the printing of the second side image 470a printed in the first frame 466a on the second side 308 of the web media so as to be in registration with a first side image 472a printed on the first frame 426a of the first side 306 of the web media.

When the second fiducial detection period 436b, or window, has begun or opened, controller 420 is to utilize the second optical sensor 416b to detect the fiducial 430b. In this example, a printing adjustment for the printing of second side image 470b is made based upon a comparison of the measured time period with an expected time period between detection of the fiducial 430b and the start of the fiducial detection period 436b. The printing adjustment to be made is to adjust timing of the second set of printheads 304 (FIG. 4A) starting the printing of the second side image 470b printed in the second frame 466b on the second side 308 of the web media so as to be in registration with a first side image 472b printed on the second frame 426b of the first side 306 of the web media.

When the third fiducial detection period 436c, or window, has begun or opened, controller 420 is to utilize the second optical sensor 416b to detect the fiducial 430c. In this example, a printing adjustment for the printing of second side image 470c is made based upon a comparison of the measured time period with an expected time period between detection of the fiducial 430c and the start of the fiducial detection period 436c. The printing adjustment to be made is to adjust timing of the second set of printheads 304 (FIG. 4A) starting the printing of the second side image 470c printed in the third frame 466c on the second side 308 of the web media so as to be in registration with a first side image 472c printed on the third frame 426c of the first side 306 of the web media.

When the fourth fiducial detection period 436d, or window, has begun or opened, controller 420 is to utilize the second optical sensor 416b to attempt to detect a fiducial. However, in this example no fiducial appears in the optical path of the second optical sensor 416b during the fourth fiducial detection period, with the result that there is no printing of a second side image in the fourth frame 466d on the second side 308 of the web media.

When the fifth fiducial detection period 436e, or window, has begun or opened, controller 420 is to utilize the second optical sensor 416b to detect the fiducial 430e. In this example, a printing adjustment for the printing of second side image 470e is made based upon a comparison of the measured time period with an expected time period between detection of the fiducial 430e and the start of the fiducial detection period 436e. The printing adjustment to be made is to adjust timing of the second set of printheads 304 (FIG. 4A) starting the printing of the second side image 470e printed in the fifth frame 466e on the second side 308 of the web media so as to be in registration with a first side image 472e printed on the fifth frame 426e of the first side 306 of the web media.

It should be noted that in the example of FIG. 4B, each of frames 1-5 (426a-e) on the first side 306 of the web media includes markings 480 (in this example represented as shaded rectangles) in the optical path of second sensor 416b that will are not to be detected by the second sensor 416b during the fiducial detection periods or windows 436a-e. Accordingly, in examples controller 420 is not to consider detection of these markings 480 by the second sensor 416b outside the fiducial detection periods for purposes of determining print adjustments for second side 308 printing. In examples these markings 480 may be for utilization in color calibration operations, as print job identifiers, or as finishing device instructions.

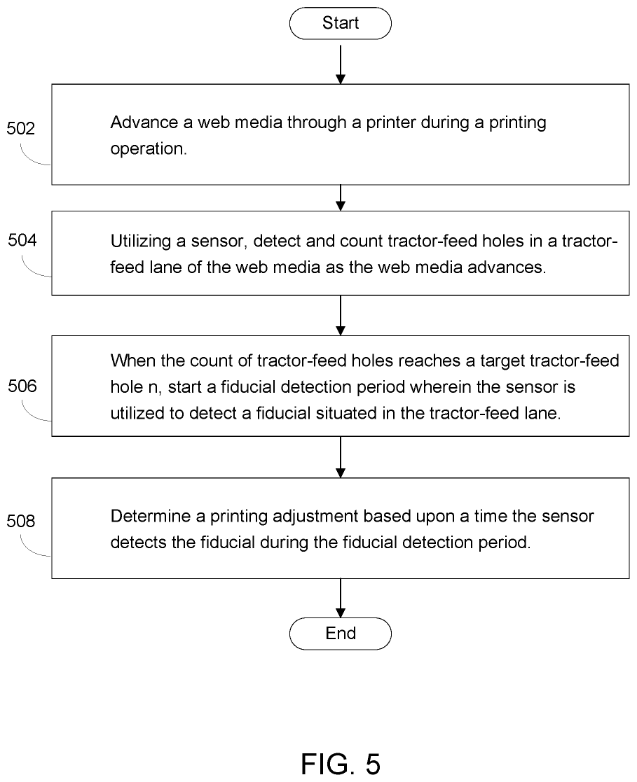

FIG. 5 is a flow diagram of implementation of a method for printing upon web media with tractor-feed holes. A web media is advanced through a printer during a printing operation (block 502). Referring back to FIGS. 1 and 2, counting engine 102 (FIG. 1) or counting module 202 (FIG. 2), when executed by processing resource 240, may be responsible for implementing block 502.

A sensor is utilized to detect and count tractor-feed holes in a tractor-feed lane of the web media as the web media advances (block 504). Referring back to FIGS. 1 and 2, counting engine 102 (FIG. 1) or counting module 202 (FIG. 2), when executed by processing resource 240, may be responsible for implementing block 504.

When the count of tractor-feed holes reaches a target tractor-feed hole n, a fiducial detection period is started wherein a sensor is to be utilized to detect a fiducial (block 506). Referring back to FIGS. 1 and 32, fiducial detection engine 104 (FIG. 1) or fiducial detection module 204 (FIG. 2), when executed by processing resource 240, may be responsible for implementing block 506.

A printing adjustment is determined based upon a time the fiducial is detected during the fiducial detection period (block 508). Referring back to FIGS. 1 and 2, printing adjustment engine 106 (FIG. 1) or printing adjustment module 206 (FIG. 2), when executed by processing resource 240, may be responsible for implementing block 508.

FIGS. 1, 2, 3A-3D, 4A, 4B, and 5 aid in depicting the architecture, functionality, and operation of various examples. In particular, FIGS. 1, 2, 3A-3D, 4A, and 4B depict various physical and logical components. Various components are defined at least in part as programs or programming. Each such component, portion thereof, or various combinations thereof may represent in whole or in part a module, segment, or portion of code that comprises executable instructions to implement any specified logical function(s). Each component or various combinations thereof may represent a circuit or a number of interconnected circuits to implement the specified logical function(s). Examples can be realized in a memory resource for use by or in connection with a processing resource. A “processing resource” is an instruction execution system such as a computer/processor-based system or an ASIC (Application Specific Integrated Circuit) or other system that can fetch or obtain instructions and data from computer-readable media and execute the instructions contained therein. A “memory resource” is a non-transitory storage media that can contain, store, or maintain programs and data for use by or in connection with the instruction execution system. The term “non-transitory” is used only to clarify that the term media, as used herein, does not encompass a signal. Thus, the memory resource can comprise a physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory (EPROM), flash drives, and portable compact discs.

Although the flow diagram of FIG. 5 shows specific orders of execution, the order of execution may differ from that which is depicted. For example, the order of execution of two or more blocks or arrows may be scrambled relative to the order shown. Also, two or more blocks shown in succession may be executed concurrently or with partial concurrence. Such variations are within the scope of the present disclosure.

It is appreciated that the previous description of the disclosed examples is provided to enable any person skilled in the art to make or use the present disclosure, Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein. All of the features disclosed in this specification (including any accompanying claims, abstract and drawings), and/or all of the blocks or stages of any method or process so disclosed, may be combined in any combination, except combinations where at least some of such features, blocks and/or stages are mutually exclusive. The terms “first”, “second”, “third” and so on in the claims merely distinguish different elements and, unless otherwise stated, are not to be specifically associated with a particular order or particular numbering of elements in the disclosure.

What is claimed is:

1. A method for printing upon web media with tractor-feed holes, comprising:
advancing a web media through a printer during a printing operation;
utilizing a sensor, detecting and counting tractor-feed holes in a tractor-feed lane of the web media as the web media advances;
when the count of tractor-feed holes reaches a target tractor-feed hole n, starting a fiducial detection period wherein a sensor is to be utilized to detect a fiducial; and
determining a printing adjustment based upon a time the fiducial is detected during the fiducial detection period.

2. The method of claim 1, wherein the fiducial to be detected is situated in the tractor-feed lane, and the sensor that is utilized to detect the fiducial is the same sensor as is utilized to detect and count the tractor-feed holes in a tractor-feed lane of the web media as the web media advances.

3. The method of claim 1, wherein the fiducial to be detected is situated outside the tractor-feed lane, wherein the sensor that is utilized to detect the fiducial is a first sensor, and wherein a second sensor is utilized to detect and count the tractor-feed holes in a tractor-feed lane of the web media as the web media advances.

4. The method of claim 1, further comprising determining a measured time period between detection of the fiducial and the start of the fiducial detection period, and wherein the printing adjustment is made based upon a comparison of the measured time period with an expected time period between detection of the fiducial and the start of the fiducial detection period.

5. The method of claim 1, wherein the fiducial detection period starts upon one from the set of a detection of the leading edge of the target tractor-feed hole n, a detection of the trailing edge of the target tractor-feed hole n, and the elapsing of a predetermined time following a detection of the leading edge of the target tractor-feed hole n.

6. The method of claim 1, wherein the fiducial detection period ends before the count of tractor-feed holes reaches n+1.

7. The method of claim 1, wherein the printer includes a plurality of printheads for forming an image up the web media according to an ink ejection timing, and wherein the print timing adjustment is to adjust the ink ejection timing.

8. The method of claim 7, wherein the plurality of printheads includes a first set of printheads and a second set of printheads, wherein the printing on the first side of the web media is performed utilizing the first set of printheads, wherein the printing on the second side of the web media is performed utilizing the second set of printheads, and wherein the printing adjustment is to adjust the ink ejection timing of the second set of printheads.

9. The method of claim 1, wherein the fiducial is a top-of-frame mark and is printed utilizing the first set of printheads.

10. A system for printing upon web media with tractor-feed holes, comprising:
a plurality of ink application components for printing an image upon a web media during a duplex printing operation, including a first set of ink application components for printing on a first side of the web media, and a second set of ink application components for printing on a second side of the web media;
a supply reel and a take-up reel for moving the web media past the first set of marking agent application components, past an optical sensor, and past the second set of marking agent application components;
a counting engine, to, utilizing detection data received from an optical sensor, count tractor-feed holes in a tractor-feed lane of the web media;
a fiducial detection engine, to, during a fiducial detection period beginning when the count of tractor-feed holes reaches a target tractor-feed hole n, utilize an optical sensor to detect a fiducial; and
a printing adjustment engine, to implement a printing adjustment based upon comparison of a measured time of the detection of the fiducial with an expected time of detection of the fiducial.

11. The system of claim 10, wherein the fiducial to be detected is situated in the tractor-feed lane, and wherein the sensor that is utilized to detect the fiducial is also utilized to detect and count the tractor-feed holes in a tractor-feed lane of the web media as the web media advances.

12. The system of claim 10, wherein the printing operation is a duplex printing operation including printing on a first side of the web media and printing on a second side of the web media, wherein detection of the fiducial on a first side of the web media is to occur during printing or following printing on the first side of the web media, and wherein the print timing adjustment is to adjust timing of starting printing of a second frame on the second side of the web media so as to be in registration with a first frame printed on the first side of the web media.

13. The system of claim 10, wherein the fiducial to be detected is situated outside the tractor-feed lane, and further comprising a first sensor that is for detecting the fiducial, and a second sensor that is for detecting and counting the tractor-feed holes in a tractor-feed lane of the web media as the web media advances.

14. A memory resource storing instructions that when executed are to cause a processing resource to cause printing of frames upon a web media that includes tractor-feed holes, comprising:
a counting module, to, utilizing detection data received from an optical sensor, count tractor-feed holes in a tractor-feed lane of a web media as the web media advances during a duplex printing operation;
a fiducial detection module, to start a fiducial detection period when the count of tractor-feed holes reaches a target tractor-feed hole n, and during the fiducial detection period utilize an optical sensor to detect a fiducial; and
a printing adjustment module, to determine a printing adjustment based upon a determination of expansion or shrinkage of the web media, the determination made based upon a comparison of a measured time period and an expected time period between the start of the fiducial detection period and the detection of the fiducial.

15. The memory resource of claim 14,
wherein the counting module, upon determining, utilizing the detection data and a predicted distance between tractor-feed holes, that an expected tractor-feed hole y at a location z was not detected by the optical sensor, is to count a virtual tractor-feed hole y at the location z; and
wherein the fiducial detection module is to determine the fiducial detection period based upon a tractor-feed holes count that includes the virtual tractor-feed hole y.
